(19) United States
(12) Patent Application Publication
(10) Pub. No.: US 2020/0154632 A1
(43) Pub. Date: May 21, 2020

(54) AUTOMATIC BOUNDARY CLOSING SYSTEM AND METHOD FOR INTELLIGENT LAWN MOWER

(71) Applicant: Chongqing Rato Intelligent Equipment Co., LTD., Chongqing City (CN)

(72) Inventors: YUANYUAN CHEN, Chongqing City (CN); ZHE NIU, Chongqing City (CN); WEI ZHONG, Chongqing City (CN); BO DING, Chongqing City (CN); QIANG WANG, Chongqing City (CN)

(21) Appl. No.: 16/748,796

(22) Filed: Jan. 21, 2020

(30) Foreign Application Priority Data
Jan. 22, 2019 (CN) 201910056418.7

(51) Int. Cl. A01D 34/00; G05D 1/02; G05D 1/00; H04W 4/021; A01D 101/00

(52) U.S. Cl. CPC A01D 34/008; G05D 1/0223; G05D 1/0272; G05D 2201/0208; H04W 4/021; G05D 1/0219; A01D 2101/00; G05D 1/0016

(57) ABSTRACT

The present invention discloses an automatic boundary closing method for an intelligent lawn mower. The method includes the following steps: starting a boundary teaching mode of the intelligent lawn mower; acquiring and storing starting point position information of the intelligent lawn mower; recording position information of the intelligent lawn mower in real time and determining whether the distance between the current position of the intelligent lawn mower and the starting point is less than or equal to a distance threshold; if the distance is less than or equal to the distance threshold, further determining whether an automatic boundary closing instruction input by a user is received; executing the automatic boundary closing instruction of the user, and generating boundary closing data by using an interpolation algorithm and storing the data; and ending the boundary teaching mode. The present invention also discloses an automatic boundary closing system for an intelligent lawn mower.

### TECHNICAL FIELD

The present invention relates to the technical field of intelligent lawn mowers, and in particular to an automatic boundary closing system and method for an intelligent lawn mower.

### BACKGROUND

With the continuous progress of computer technology and artificial intelligence technology, more and more people are beginning to consider how to apply intelligent technology to agriculture. Agricultural robots are a new type of multifunctional agricultural machinery used in agricultural production, and are products of the integration and development of intelligent robot technology and automation technology. A number of competitive robots have successfully developed now, including weeding robots, fertilizer application robots, spraying robots, and harvesting robots, which can completely realize the robotic assembly line operation from planting to harvest of crops, without consuming manpower. However, there is still a blank in lawn mowing for high-end areas such as gardens and golf courses due to their special mowing requirements. Thus, garden mowing robots emerge. Most of traditional mowing robots rely on remote control. This method does not completely liberate humans from a mowing task in a strict sense, but on the contrary, forces people to always pay close attention to the operating state of the robots. Although users no longer need to actually operate the lawn mowers, it increases the user's operation requirements, which runs counter to intelligence.

During the mapping process, to create information of a complete global map, it is necessary to acquire information of an end-to-end closure position status when the map is built. However, because the mapping is performed manually and the position of the moving robot cannot be easily controlled due to its bulky volume, it takes a lot of time to find a point set close to the starting point in principle. The labor time of the mowing robot user is increased indirectly. The reason for this is mainly because there is no accurate and reliable motion control system which enables the robot to strictly follow the prescribed path, and on the other hand there is no effective algorithm which can enable the robot to perform an automatic boundary closing curve processing close to the initial position according to the choice of the staff. Therefore, it is necessary to design an automatic boundary closing system and method for an intelligent lawn mower.

### SUMMARY

An object of the present invention is to provide an automatic boundary closing system and method for an intelligent lawn mower to solve the problems raised in the background art described above.

To achieve the above object, the present invention provides the following technical solutions.

An automatic boundary closing method for an intelligent lawn mower includes the following steps:

starting a boundary teaching mode of the intelligent lawn mower;

acquiring and storing starting point position information of the intelligent lawn mower;

recording position information of the intelligent lawn mower in real time and determining whether the distance between the current position of the intelligent lawn mower and the starting point is less than or equal to a distance threshold;

if the distance is less than or equal to the distance threshold, further determining whether an automatic boundary closing instruction input by a user is received;

executing the automatic boundary closing instruction of the user, and generating boundary closing data by using an interpolation algorithm and storing the data; and

ending the boundary teaching mode.

The present invention also provides an automatic boundary closing system for an intelligent lawn mower, including:

a positioning module configured to acquire position information of the intelligent lawn mower;

an input module configured to receive an automatic boundary closing instruction input by a user;

a storage module configured to store starting point position information, real-time position information, distance threshold information, and boundary closing data information of the intelligent lawn mower;

a computing module configured to determine whether the distance between the current position of the intelligent lawn mower and the starting point is less than or equal to the threshold; and

a control module configured to start or end a boundary teaching mode of the intelligent lawn mower, and generate boundary closing data by using an interpolation algorithm when the distance between the current position of the intelligent lawn mower and the starting point is less than or equal to the threshold and the automatic boundary closing instruction input by the user is received.

Compared with the prior art, the present invention has the following beneficial effects: operators are given different robot operating speed prompts at different approach distances, and a corresponding interpolation algorithm is determined based on human intervention distances, so that when the intelligent lawn mower is getting close to the teaching starting position, the closing method can automatically prompt the closing selection point, leaving a selection right to the staff to decide autonomously. If permitted, the automatic closing is performed in an appropriate manner.

### BRIEF DESCRIPTION OF THE DRAWINGS

FIG. 1 is a flowchart of an automatic boundary closing method for an intelligent lawn mower according to a preferred embodiment of the present invention.

FIG. 2 is a block diagram of an automatic boundary closing system for an intelligent lawn mower according to a preferred embodiment of the present invention.

FIG. 3 is a schematic diagram of an overall structure of an automatic boundary closing system for an intelligent lawn mower according to another preferred embodiment of the present invention.

FIG. 4 is a flowchart of an automatic boundary closing method for an intelligent lawn mower according to another preferred embodiment of the present invention.

FIG. 5 is a schematic diagram of finding points by the intelligent lawn mower.

FIG. 6 is a schematic diagram of an interpolation part of the intelligent lawn mower.

FIG. 7 is a first schematic diagram of an automatic closing logic of the intelligent lawn mower.

FIG. 8 is a second schematic diagram of the automatic closing logic of the intelligent lawn mower.

FIG. 9 is a third schematic diagram of the automatic closing logic of the intelligent lawn mower.

FIG. 10 is a fourth schematic diagram of the automatic closing logic of the intelligent lawn mower.

FIG. 11 is a fifth schematic diagram of the automatic closing logic of the intelligent lawn mower.

FIG. 12 is a sixth schematic diagram of the automatic closing logic of the intelligent lawn mower.

### DETAILED DESCRIPTION

In the following, the technical solutions in the embodiments of the present invention will be clearly and completely described with reference to the drawings in the embodiments of the present invention. Obviously, the described embodiments are only a part of the embodiments of the present invention, but not all the embodiments. Based on the embodiments of the present invention, all other embodiments obtained by a person of ordinary skill in the art without creative efforts shall fall within the protection scope of the present invention.

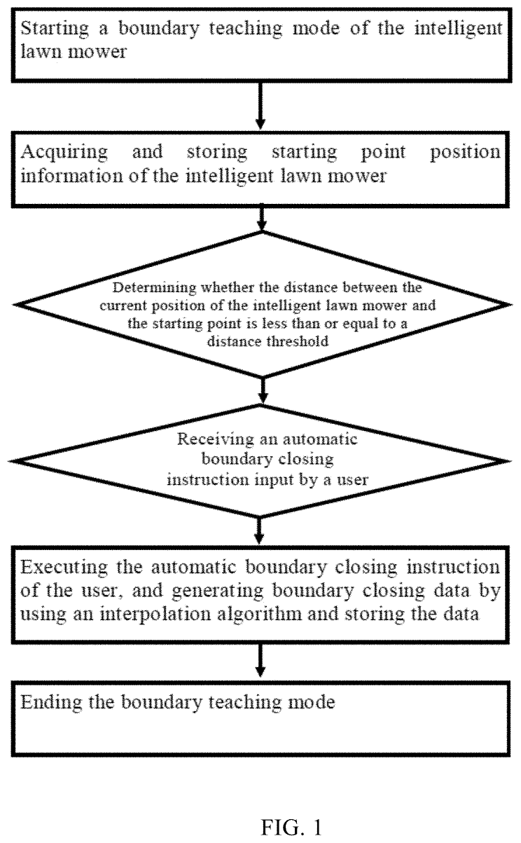

Referring to FIG. 1, which is a flowchart of an automatic boundary closing method for an intelligent lawn mower according to a preferred embodiment of the present invention. The automatic boundary closing method for the intelligent lawn mower according to the preferred embodiment includes the following steps.

Step a, a boundary teaching mode of the intelligent lawn mower is started.

Step b, starting point position information of the intelligent lawn mower is acquired and stored.

Step c, position information of the intelligent lawn mower is recorded in real time and whether the distance between the current position of the intelligent lawn mower and the starting point is less than or equal to a distance threshold is determined.

Step d, if the distance is less than or equal to the distance threshold, whether an automatic boundary closing instruction input by a user is received is further determined.

Step e, the automatic boundary closing instruction of the user is executed, and boundary closing data is generated by using an interpolation algorithm and stored.

Step f, the boundary teaching mode is ended.

Further, in step e, after the step of generating boundary closing data by using the interpolation algorithm and storing the data, the method further includes: adjusting an operating speed value of the intelligent lawn mower according to the distance between the current position of the intelligent lawn mower and the starting point. In this embodiment, there are multiple distance thresholds, and each distance threshold corresponds to one operating speed value of the intelligent lawn mower according to an algorithm.

Further, after the step of recording the position information of the intelligent lawn mower in real time and determining whether the distance between the current position of the intelligent lawn mower and the starting point is less than or equal to the distance threshold, the method further includes the step of: displaying a prompt message on a control panel of the intelligent lawn mower to prompt the user to perform an automatic boundary closing operation.

Further, before the step of displaying the prompt message on the control panel of the intelligent lawn mower, the method further includes the steps of: determining whether the current position of the intelligent lawn mower is going away from or getting close to the starting point, when the current position is getting close to the starting point and the distance from the starting point is less than or equal to the distance threshold, displaying the prompt message on the control panel of the intelligent lawn mower; and when the current position is going away from the starting point and the distance from the starting point is less than or equal to the distance threshold, displaying no prompt message on the control panel of the intelligent lawn mower.

Further, the automatic boundary closing method for the intelligent lawn mower further includes the step of: if the distance between the current position and the starting point of the intelligent lawn mower exceeds the distance threshold when the automatic boundary closing instruction of the user is received, determining that the received automatic boundary closing instruction is invalid.

Further, before the step of starting the boundary teaching mode of the intelligent lawn mower, the method further includes the step of setting an automatic boundary closing distance threshold and storing the same.

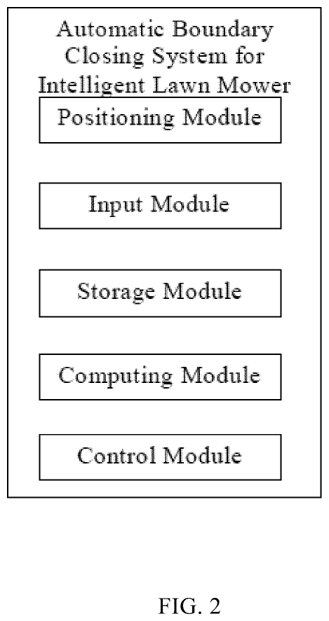

Referring to FIG. 2, which is a block diagram of an automatic boundary closing system for an intelligent lawn mower according to a preferred embodiment of the present invention. The automatic boundary closing system for the intelligent lawn mower according to the preferred embodiment includes a positioning module, an input module, a storage module, a computing module, and a control module. The positioning module is configured to acquire position information of the intelligent lawn mower. The input module is configured to receive an automatic boundary closing instruction input by a user. The storage module is configured to store starting point position information, real-time position information, distance threshold information, and boundary closing data information of the intelligent lawn mower. The computing module is configured to determine whether the distance between the current position of the intelligent lawn mower and the starting point is less than or equal to the threshold. The control module is configured to start or end the boundary teaching mode of the intelligent lawn mower, and generate boundary closing data by using an interpolation algorithm when the distance between the current position of the intelligent lawn mower and the starting point is less than or equal to the threshold and the automatic boundary closing instruction input by the user is received.

Further, the automatic boundary closing system for the intelligent lawn mower further includes a speed adjustment module. The speed adjustment module is configured to adjust an operating speed value of the intelligent lawn mower according to the distance between the current position of the intelligent lawn mower and the starting point.

Further, the automatic boundary closing system for the intelligent lawn mower further includes a display module. The display module is configured to display a prompt message when the distance between the current position of the intelligent lawn mower and the starting point is less than or equal to the distance threshold to prompt the user to perform an automatic boundary closing operation.

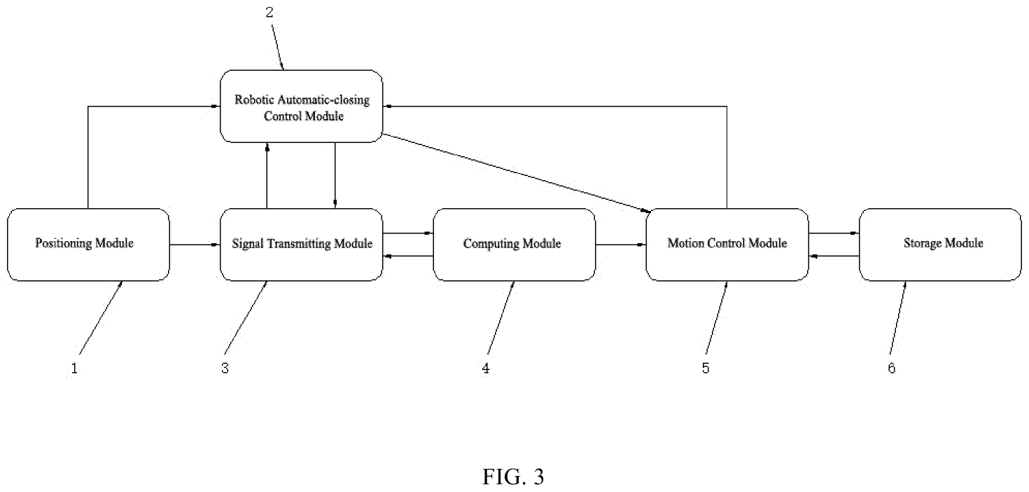

Referring to FIG. 3, the present invention also provides a technical solution: an automatic boundary closing system for an intelligent lawn mower. The system includes a positioning module 1, a robotic automatic-closing control module 2, a signal transmitting module 3, a computing module 4, a motion control module 5 and a storage module 6. The positioning module 1 is connected with the robotic automatic-closing control module 2 and the signal transmitting module 3 respectively through signals. The robotic automatic-closing control module 2 is interactively connected with the signal transmitting module 3 through signals. The signal transmitting module 3 is interactively connected with the computing module 4 through signals. The computing module 4 is connected with the motion control module 5 through signals. The motion control module 5 is interactively connected with the robotic automatic-closing control module 2 and the storage module 6 through signals.

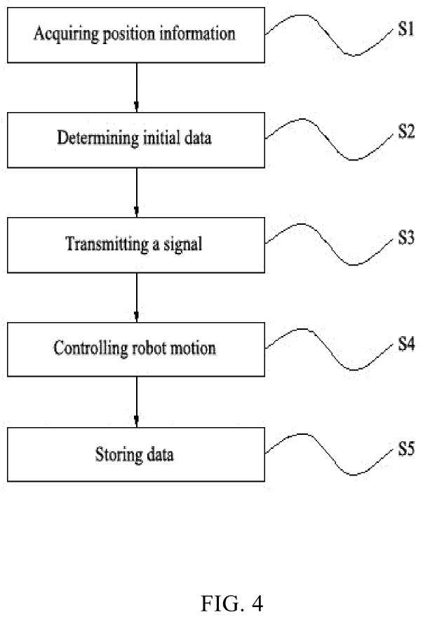

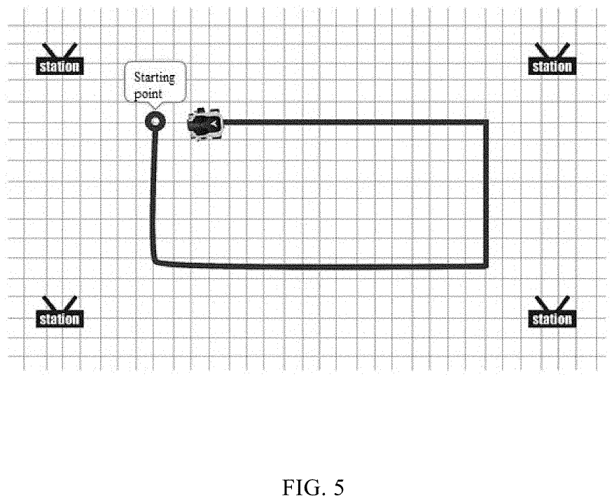

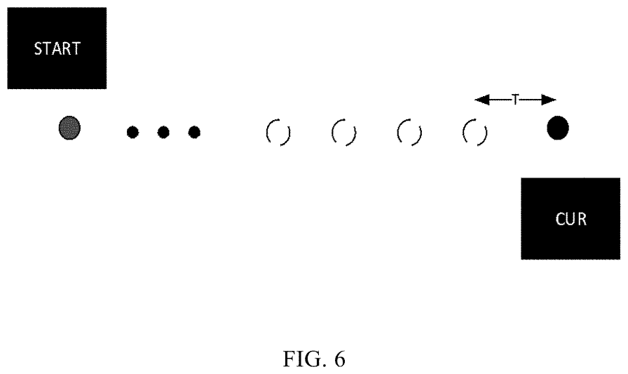

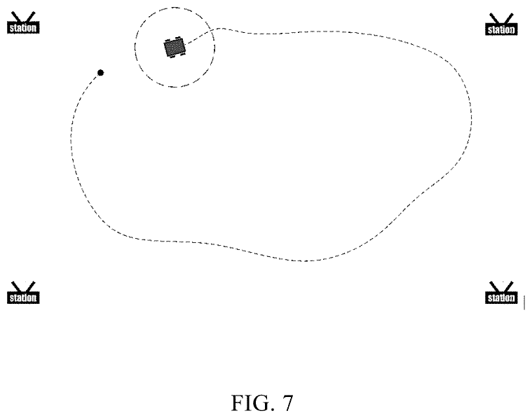

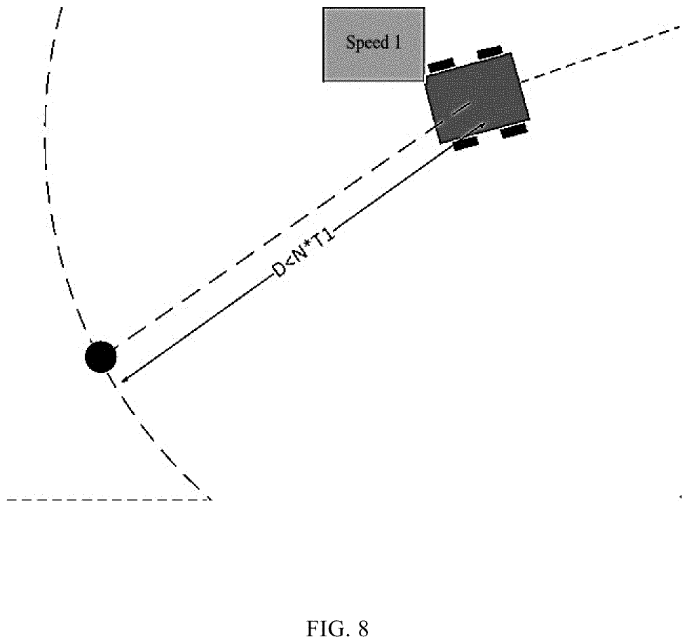

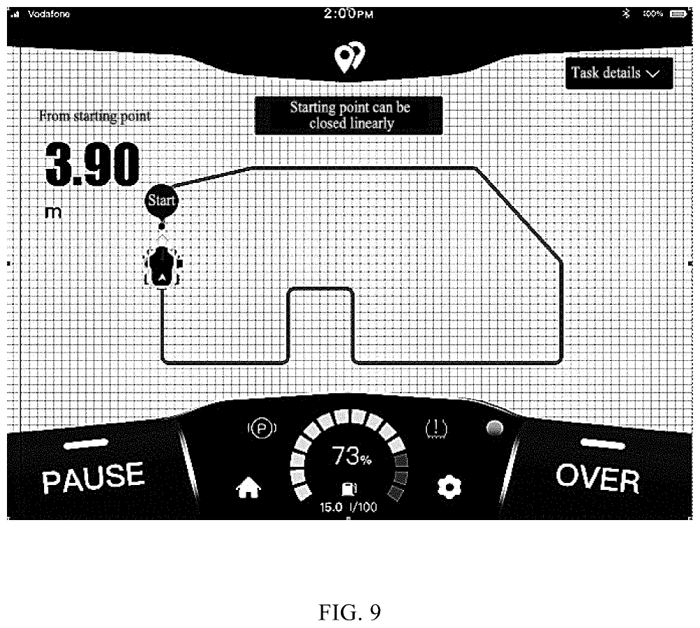

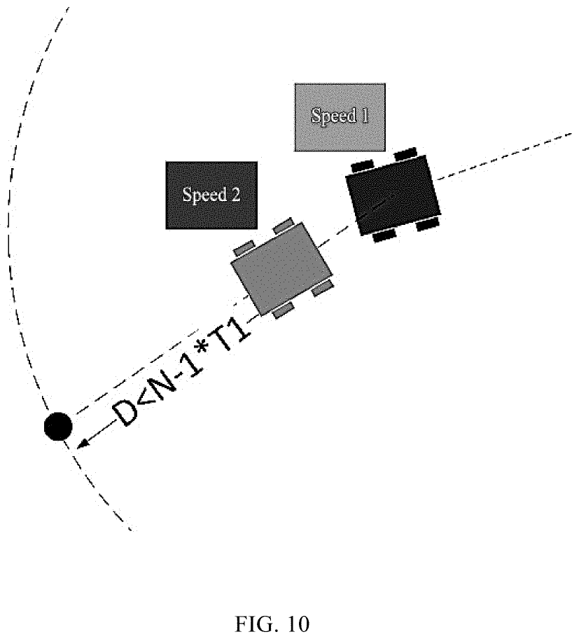

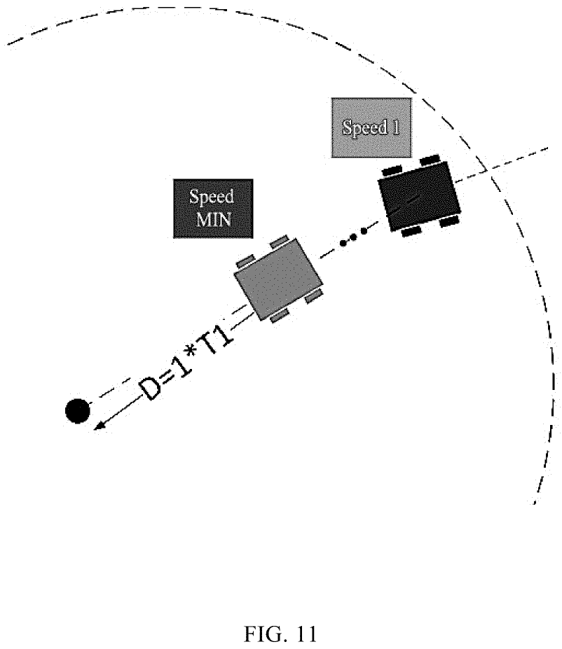

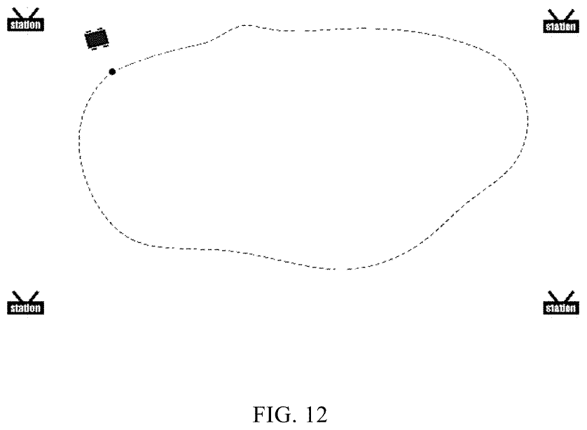

Referring to FIGS. 4-12, the present invention also provides another automatic boundary closing method for an intelligent lawn mower. The method includes the following steps: step 1, acquiring position information; step 2, determining initial data; step 3, transmitting a signal; step 4, controlling robot motion; and step 5, storing data.

In step 1, the positioning module 1 acquires real-time position data of the robot and all position data points in a map construction process.

In step 2, the storage module 6 loads the pre-saved data, the robotic automatic-closing control module 2 fetches starting point data, the computing module 4 calculates the distance between the real-time position of the robot and the starting point, and the signal transmitting module 3 transmits the calculation result to a host computer.

In step 3, when the host computer determines that the distance between the real-time position of the robot and the starting point reaches a threshold N*T, the signal transmitting module 3 sends an approach instruction to the robot.

In step 4, according to different values of the threshold N*T, the host computer transmits the corresponding instructions to the computing module 4, and the motion control module 5 feeds back different speeds after receiving the different instructions, so that the robot walks according to different speeds and travels at the slowest speed until a single threshold is reached.

In step 5, after manual intervention, the computing module 4 performs a linear interpolation operation in accordance with a preset step length according to the distance between the real-time position of the robot and the starting point, obtains closing data, and stores the data in the storage module 6.

According to the above technical solution, the motion control module 5 performs low-level motion control on the robot to achieve stable control of the robot body during teaching.

According to the above technical solution, in step 4, when the robotic automatic-closing control module 2 determines that the robot has exceeded the starting point when manual intervention is performed, the computing module 4 obtains interpolation data in two directions according to quadrant selection as well as the current position of the robot and the starting point position.

According to the above technical solution, during the end process, if it is not automatically closed after manual operation, the robotic automatic-closing control module 2 is allowed to select automatic closing control within the threshold range. If the threshold is exceeded, the robotic automatic-closing control module 2 is not allowed to perform automatic closing control.

According to the above technical solution, in step 1, the positioning module 1 uses a civilian carrier GPS positioning sensor to acquire the real-time position data of the robot and all position data points in the map construction process in cooperation with base stations within a preset search range. Of course, in other embodiments, other positioning sensors may also be adopted to acquire the real-time position of the robot. This patent application is not limited to civil carrier GPS positioning sensors.

According to the above technical solution, in step 2, when the storage module 6 loads the pre-saved data, the robotic automatic-closing control module 2 fetches the starting point data after determining that the data is valid.

According to the above technical solution, in step 2, if the distance between the real-time position of the robot and the starting point calculated by the computing module 4 is less than a preset value, the robotic automatic-closing control module 2 performs no operation.

According to the above technical solution, the method includes a maintenance thread. The computing module 4 is preset with a linear interpolation algorithm. In step 4, the maintenance thread first determines the distance between the current position of the robot and the starting point position, and performs a linear interpolation calculation based on the current speed at every threshold to obtain a decreased speed value. The motion control module 5 performs a deceleration operation after acquiring the decreased speed value.

According to the above technical solution, after the robotic automatic-closing control module 2 obtains the automatic closing command, the computing module 4 recalculates the distance between the current position of the robot and the starting point position, performs a linear interpolation calculation on the data at every threshold to obtain closing data and stores the data in the storage module 6.

Based on the above, the present invention has the advantage as follows. In use, the positioning module 1 uses the civilian carrier GPS positioning sensor or other positioning sensors to acquire the real-time position data of the robot and all position data points in the map construction process in cooperation with the base stations within the preset search range. The storage module 6 loads the pre-saved data. The robotic automatic-closing control module 2 fetches the starting point data. The computing module 4 calculates the distance between the real-time position of the robot and the starting point. The signal transmitting module 3 transmits the calculation result to the host computer. When the host computer determines that the distance between the real-time position of the robot and the starting point reaches the threshold N*T, the signal transmitting module 3 sends the approach signal to the robot. According to the different values of the threshold N*T, the host computer transmits corresponding instructions to the computing module 4. The motion control module 5 feeds back different speeds after receiving the different instructions to instruct the robot to walk at different speeds and travel at the slowest speed until it reaches a single threshold. After manual intervention, the computing module 4 performs the linear interpolation operation in accordance with the preset step length according to the distance between the real-time position of the robot and the starting point to obtain closing data and stores the data in the storage module 6.

What is claimed is:

1. An automatic boundary closing method for an intelligent lawn mower, the method comprising the steps of:
starting a boundary teaching mode of the intelligent lawn mower;
acquiring and storing starting point position information of the intelligent lawn mower;
recording position information of the intelligent lawn mower in real time and determining whether the distance between the current position of the intelligent lawn mower and the starting point is less than or equal to a distance threshold;
if the distance is less than or equal to the distance threshold, further determining whether an automatic boundary closing instruction input by a user is received;
executing the automatic boundary closing instruction of the user, and generating boundary closing data by using an interpolation algorithm and storing the data; and
ending the boundary teaching mode.

2. The automatic boundary closing method for the intelligent lawn mower according to claim 1, wherein after the step of generating the boundary closing data by using the interpolation algorithm and storing the data, the method further comprises the step of:
adjusting an operating speed value of the intelligent lawn mower according to the distance between the current position of the intelligent lawn mower and the starting point.

3. The automatic boundary closing method for the intelligent lawn mower according to claim 2, wherein there are multiple distance thresholds, and each distance threshold corresponds to one operating speed value of the intelligent lawn mower according to an algorithm.

4. The automatic boundary closing method for the intelligent lawn mower according to claim 1, wherein after the step of recording the position information of the intelligent lawn mower in real time and determining whether the distance between the current position of the intelligent lawn mower and the starting point is less than or equal to the distance threshold, the method further comprises the step of: if the distance is less than or equal to the distance threshold, displaying a prompt message on a control panel of the intelligent lawn mower to prompt the user to perform an automatic boundary closing operation.

5. The automatic boundary closing method for the intelligent lawn mower according to claim 4, wherein before the step of displaying the prompt message on the control panel of the intelligent lawn mower, the method further comprises the step of: determining whether the current position of the intelligent lawn mower is going away from or getting close to the starting point, when the current position is getting close to the starting point and the distance from the starting point is less than or equal to the distance threshold, displaying a prompt message on a control panel of the intelligent lawn mower; or when the current position is going away from the starting point and the distance from the starting point is equal to or less than the distance threshold, displaying no prompt message on the control panel of the intelligent lawn mower.

6. The automatic boundary closing method for the intelligent lawn mower according to claim 1, further comprising the step of: if the distance between the current position of the intelligent lawn mower and the starting point exceeds the distance threshold when the automatic boundary closing instruction is received from the user, determining that the received automatic boundary closing instruction is invalid.

7. The automatic boundary closing method for the intelligent lawn mower according to claim 1, wherein before the step of starting the boundary teaching mode of the intelligent lawn mower, the method further comprises the step of: setting an automatic boundary closing distance threshold and storing the same.

8. An automatic boundary closing system for an intelligent lawn mower, the system comprising:
a positioning module configured to acquire position information of the intelligent lawn mower;
an input module configured to receive an automatic boundary closing instruction input by a user;
a storage module configured to store starting point position information, real-time position information, distance threshold information, and boundary closing data information of the intelligent lawn mower;
a computing module configured to determine whether the distance between the current position of the intelligent lawn mower and the starting point is less than or equal to the threshold; and
a control module configured to start or end a boundary teaching mode of the intelligent lawn mower, and generate boundary closing data by using an interpolation algorithm when the distance between the current position of the intelligent lawn mower and the starting point is less than or equal to the threshold and the automatic boundary closing instruction input by the user is received.

9. The automatic boundary closing system for the intelligent lawn mower according to claim 8, the system further comprising: a speed adjustment module configured to adjust an operating speed value of the intelligent lawn mower according to the distance between the current position of the intelligent lawn mower and the starting point.

10. The automatic boundary closing system for the intelligent lawn mower according to claim 8, the system further comprising: a display module configured to display a prompt message when the distance between the current position of the intelligent lawn mower and the starting point is less than or equal to the distance threshold to prompt the user to perform an automatic boundary closing operation.
